(19) United States
(12) Patent Application Publication
(10) Pub. No.: US 2012/0154397 A1
(43) Pub. Date: Jun. 21, 2012

(54) METHOD AND SYSTEM FOR GENERATING MESH FROM IMAGES

(75) Inventors: Andrey Chernikov, Virginia Beach, VA (US); Nikos Chrisochoides, Williamsburg, VA (US)

(73) Assignee: Old Dominion University Research Foundation, Washington, DC (US)

(21) Appl. No.: 13/311,335

(22) Filed: Dec. 5, 2011

Related U.S. Application Data
(60) Provisional application No. 61/419,632, filed on Dec. 3, 2010.
(60) Provisional application No. 61/482,797, filed on May 5, 2011.

(51) Int. Cl. G06T 17/20

(52) U.S. Cl. 345/420

(57) ABSTRACT

A method for generating mesh from an image. The method includes inputting an image; setting a quality bound and a fidelity bound for a mesh to be generated; generating an initial mesh for the image with a maximum fidelity and a very high quality; generating a refined mesh by coarsening the initial mesh while maintaining the quality bound and the fidelity bound. The refined mesh includes a smaller number of elements than that of the initial mesh.

### RELATED APPLICATIONS

This Application claims a priority to Provisional Application No. 61/419,632 filed on Dec. 3, 2010, and Provisional Application No. 61/482,797 filed on May 5, 2011, the entirety of each of which is incorporated herein by reference.

### BACKGROUND

The problem of unstructured Image-To-Mesh conversion (I2M) is as follows. Given an image as a collection of voxels, such that each voxel is assigned a label of a single tissue or of the background, construct a tetrahedral mesh that overlays the tissues and conforms to their boundaries.

There is a large body of work on constructing guaranteed quality meshes for Computer Aided Design (CAD) models. The specificity of CAD-oriented approaches is that the meshes have to match exactly to the boundaries of the models. The most widely used guaranteed-quality CAD-oriented approach is based on Delaunay refinement [6]. However, the problem with Delaunay refinement in 3D is that it allows only for a bound on circumradius-to-shortest edge ratio of tetrahedra, which does not help to improve the dihedral angles. A bound represents a criterion for evaluating the quality of an element in the mesh. As a result, almost flat tetrahedra called slivers can survive. There are a number of post-processing techniques to eliminate slivers [2-4, 9, 14, 21]. While some of them have been shown to produce very good dihedral angles in practice, no implementation is available that can guarantee significant (1° and above) dihedral angle bounds.

Labelle and Shewchuk [8] described a guaranteed quality tetrahedral meshing algorithm for general surfaces. They offer a one-sided fidelity guarantee (from the mesh to the model) in terms of the Hausdorff distance, and, provided the surface is sufficiently smooth, also the guarantee in the other direction (from the model to the mesh). Their algorithm first constructs an octree that covers the model, then fills the octree leaves with high quality template elements, and finally warps the mesh vertices onto the model surface, or inserts vertices on the surface, and locally modifies the mesh. Using interval arithmetic, they prove that new elements have dihedral angles above a certain threshold. However, images are not smooth surfaces and this technique has not been extended to mesh images. One approach could be to interpolate or approximate the boundary pixels by a smooth surface, but it would be complicated by the need to control the maximum approximation (interpolation) error. On the other hand, an I2M solution can benefit from the fact that images provide more information on their structure than general surfaces.

There are also heuristic solutions [5, 10] to the I2M problem that fall into two categories: (1) first coarsen the boundary of the image, and then apply CAD-based algorithms to construct the final mesh, (2) construct the mesh which covers the image, and then warp some of the mesh vertices onto the image surface. The first approach tries to address the fidelity before the quality requirements, while the second approach does it in reverse order. Neither of these approaches is able to guarantee the quality of elements in terms of dihedral angles. As a result, the output of one step does not produce an optimal input for the other step.

### SUMMARY

According to an embodiment, the present disclosure is directed to a CAD system and method therefor for generating mesh from an image. The method includes inputting an image; setting a quality bound and a fidelity bound for a mesh to be generated; generating an initial mesh for the image with the according to the quality bound and the fidelity bound; and generating a mesh with fewer elements by coarsening the initial mesh while maintaining the quality bound and the fidelity bound. The final mesh includes a smaller number of elements than that of the initial mesh.

According to an embodiment, the quality bound includes a dihedral angle requirement, and the fidelity bound includes a Hausdorff distance requirement.

According to an embodiment, the image is a three-dimensional image, and the initial mesh generating step includes: generating a mesh overlaying a plurality of voxels, each of which is assigned a uniformed material property, and distributing the voxels through triangulation.

According to an embodiment, the voxels are assigned integer coordinates corresponding to voxel indices.

According to an embodiment, the refining step includes: merging selected vertexes with adjacent vertex, the vertexes being selected according to the quality bound and the fidelity bound so that after merge, the quality bound and the fidelity bound of the mesh are still satisfied.

According to an embodiment, a boundary vertex is merged only with anther boundary vertex that is on the same boundary as the boundary vertex.

According to another embodiment, the present disclosure is directed to a recording medium storing a program that instructs a computer to generate a mesh from an image according to the above claimed methods.

### BRIEF DESCRIPTION OF DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates functional modules of a computer according to an embodiment.

FIG. 2a illustrates an exemplary input 2D image according to an embodiment.

FIG. 2b illustrates an exemplary quadtree with refined leaves of the exemplary 2D image according to an embodiment.

FIG. 2c illustrates an exemplary Euclidean distance transform of the exemplary 2D image according to an embodiment.

FIG. 2d illustrates exemplary leaves that are within the fidelity bound of the exemplary input 2D image according to an embodiment.

FIG. 2e illustrates an exemplary initial fine mesh of the exemplary input 2D image according to an embodiment.

FIG. 2f illustrates an exemplary decimated mesh of the exemplary input 2D image according to an embodiment.

FIG. 3a illustrates a Hausdorff distance according to an embodiment.

FIG. 3b illustrates another Hausdorff distance according to an embodiment.

FIG. 4 illustrates an exemplary union of all possible edges of a triangulation according to an embodiment.

FIG. 5a illustrates a possible shape of an initial tetrahedra filling a cubic leaf according to an embodiment.

FIG. 5b illustrates another possible shape of an initial tetrahedra filling a cubic leaf according to an embodiment.

FIG. 5c illustrates another possible shape of an initial tetrahedra filling a cubic leaf according to an embodiment.

FIG. 5d illustrates another possible shape of an initial tetrahedra filling a cubic leaf according to an embodiment.

FIG. 5e illustrates another possible shape of an initial tetrahedra filling a cubic leaf according to an embodiment.

FIGS. 6a-c illustrate exemplary vertex merging operations according to an embodiment.

FIGS. 7a-c illustrate a breakdown of the total LD time into major computational parts as the diameter of a sphere varies from 100 to 400 voxels according to an embodiment.

FIG. 8 illustrates a three-dimensional image of the abdominal atlas according to an embodiment.

FIG. 9 illustrates a slice through the LD mesh of the abdominal atlas according to an embodiment.

FIG. 10 illustrates a three-dimensional image of the brain atlas according to an embodiment.

FIG. 11 illustrates a slice through the LD mesh of the brain atlas according to an embodiment.

FIG. 12a-d illustrate a breakdown of the total LD time for the abdominal atlas according to an embodiment.

FIGS. 13a-d illustrate a breakdown of the total LD time for the brain atlas according to an embodiment.

FIGS. 14a-b illustrate final number of tetrahedral in the mesh using LD according to an embodiment.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as ‘consisting essentially of’ and “consists essentially of” have the meaning ascribed to them in U.S. patent law; that is, they allow for elements not explicitly recited, but exclude elements that are found in the prior art or that affect a basic or novel characteristic of the invention. Embodiments of the present invention are disclosed or are apparent from and encompassed by, the following description.

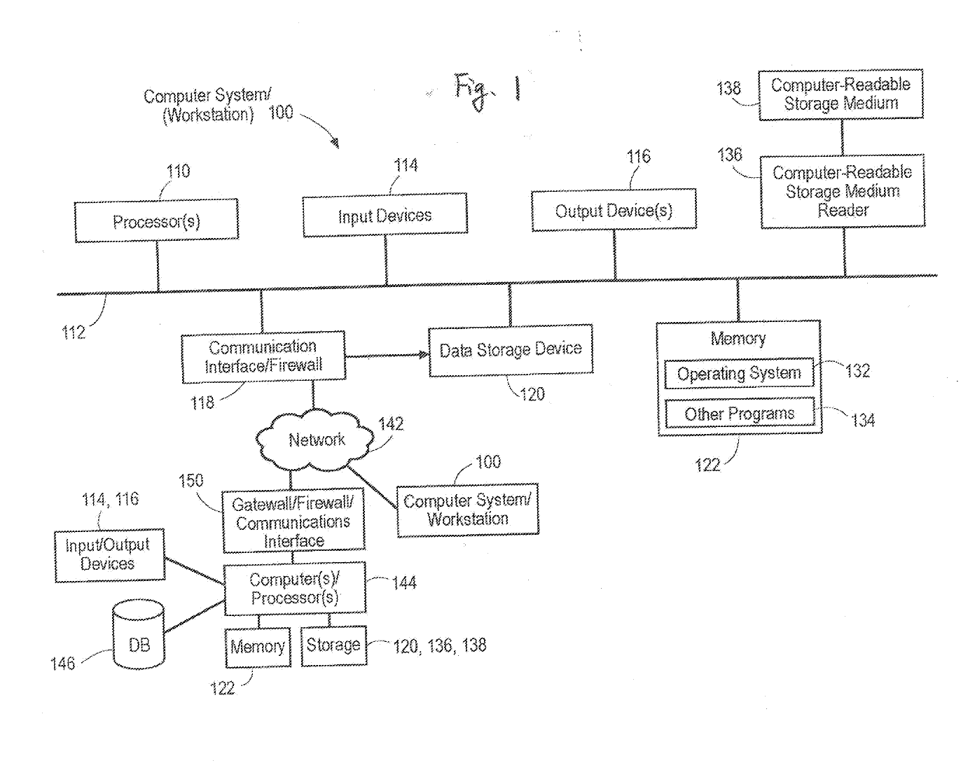

Embodiments of the invention may be implemented by a programmable digital computer or a system using one or more programmable digital computers and computer readable storage media, including those designed for processing CAD-based algorithms as known to those of ordinary skill in the art. In one embodiment, FIG. 1 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one computer readable medium or data storage device 120 such as a magnetic disk or an optical disk and memory 122 such as Random-Access Memory (RAM), each coupled to the communications channel 112. The communications interface 118 may be coupled to a network 142.

One skilled in the art will recognize that many variations of the system 100 are possible, e.g., the system 100 may include multiple channels or buses 112, various arrangements of storage devices 120 and memory 122, as different units or combined units, one or more computer-readable storage medium (CRSM) readers 136, such as, e.g., a magnetic disk drive, magneto-optical drive, optical disk drive, or flash drive, multiple components of a given type, e.g., processors 110, input devices 114, communications interfaces 118, etc.

In one or more embodiments, computer system 100 communicates over the network 142 with at least one computer 144, which may comprise one or more host computers and/or server computers and/or one or more other computers, e.g. computer system 100, performing host and/or server functions including web server and/or application server functions. In one or more embodiments, a database 146 is accessed by the at least one computer 144. The at least one computer 144 may include components as described for computer system 100, and other components as is well known in the computer arts. Network 142 may comprise one or more LANS, WANS, intranets, the Internet, and other networks known in the art. In one or more embodiments, computer system 100 is configured as a workstation that communicates with the at least one computer 144 over the network 142. In one or more embodiments, computer system 100 is configured as a client in a client-server system in which the at least one other computer comprises one or more servers. Additional computer systems 100, any of which may be configured as a work station and/or client computer, may communicate with the at least one computer 144 and/or another computer system 100 over the network 142.

The present disclosure discloses an algorithm for tetrahedral image-to-mesh conversion which allows for guaranteed bounds on the dihedral angle and on the distance between the boundaries of the mesh and the boundaries of the tissues. The algorithm produces a relatively small number of mesh elements that comply with these bounds. The present disclosure also describes and evaluates an implementation of the proposed algorithm that is compatible in performance with a state-of-the art Delaunay code, but in addition solves the small dihedral angle problem. The algorithm for constructing meshes is suitable for real-time finite element analysis with the following exemplary advantages:

1. Elements do not have arbitrarily small angles which lead to poor conditioning of the stiffness matrix in Finite Element (FE) Analysis for biomechanics applications. In particular, all dihedral angles are above a user-specified lower bound which can be set to any value up to 35.26°. In contrast, guaranteed quality Delaunay methods only satisfy a bound on circumradius-to-shortest edge ratio which in 3D does not imply a bound on dihedral angles.

2. The mesh offers a reasonably close representation (fidelity) of the underlying tissues. Since the image is already an approximation (up to a pixel granularity) of a continuous physical object, even a strict matching of the mesh to individual pixel's boundaries by conventional methods may not lead to a mesh which is completely faithful to the boundaries of the object. Moreover, conventional approaches generally produce a large number of elements that will slow down the solver. Instead, the algorithm as set forth in the present disclosure is to expose parameters that allow for a trade-off between the fidelity and the final number of elements with the goal of improving the end-to-end execution time of the FE analysis codes.

3. The number of tetrahedra in the mesh is relatively small and that the two requirements discussed above are satisfied. This requirement is based on the cost of assembling and solving a sparse system of linear equations in the finite element method, which directly depends on the number of tetrahedra [20, 23].

4. The mesh may be successfully constructed within tight real-time time constraints enforced by clinical applications. As exemplified in the disclosure, an implementation of the algorithm is close in performance and even faster than a state-of-the art Delaunay code.

The method and system for generating mesh from images as set forth in the present disclosure simultaneously satisfy the quality and the fidelity requirements. An initial fine mesh with very high quality and fidelity is initially constructed. Such a mesh is feasible due to the specific structure of the input, which is a collection of cubic blocks corresponding to the voxels of the image. This initial mesh may have a large number of elements due to the fact that it is a one-fits-all solution with respect to the angle and fidelity parameters, for the given image, since it satisfies the highest dihedral angle and fidelity bounds. A post-processing decimation step is implemented that coarsens the mesh to a lower number of elements while at all times maintaining the required fidelity and quality bounds. Mesh coarsening using vertex removal operation has been employed in various formulations in a large number of works previously for a variety of optimization problems [7, 11, 13, 15, 22]. The approach disclosed herein may appear, on its face, to require excessive amounts of computational time and storage. But, in various embodiments, it can be used to mesh three-dimensional images of practically significant sizes even on a regular desktop workstation. Furthermore, the time measurements show that for two complex medical atlas images (brain and abdominal) it is 28% to 42% faster than a state-of-the art Delaunay software.

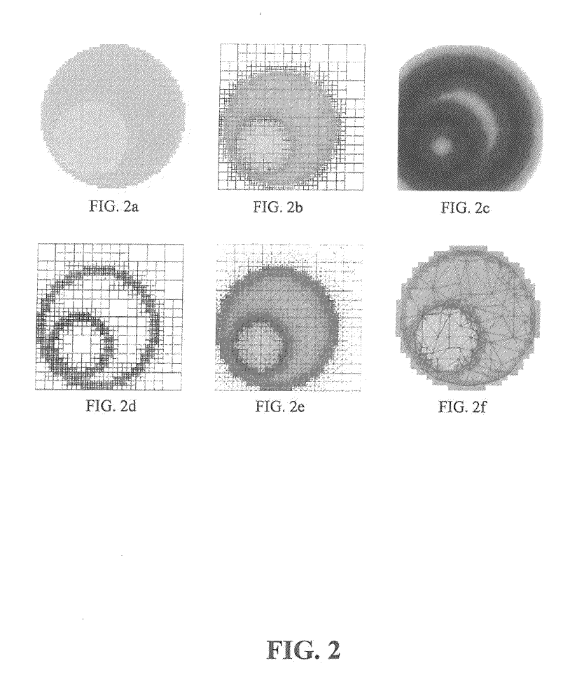

Algorithm. The mesh generating method as set forth in the present disclosure works both for 2D and for 3D images. For explanation purposes, in FIG. 2(a), a simple 2D example of an image needs to be converted into a triangular mesh. The size of this image is 50×50 voxels. It defines two circular objects 1 and 2, which could represent, for example, tissues or materials, one within another.

The mesh needs to provide a faithful representation of the underlying tissues, i.e., each element needs to be marked with the physical properties of a unique type of tissue. To measure the distance between the boundaries of the two regions (the image of a tissue and the corresponding sub-mesh), a Hausdorff distance is used. It can be specified as either a two-sided distance, or a one-sided distance. For tissue boundary I and mesh boundary M, the one-sided distance from I to M is given by:

$$H ( I M ) = {max}_{i ∈ I} {min}_{m ∈ M} d ( i , m ) ,$$

where d(·, ·) is the regular Euclidean distance. The one-sided distance from M to I is given similarly by

$$H ( M I ) = {max}_{m ∈ M} {min}_{i ∈ I} d ( m , i ) .$$

Note that H(I→M) is generally not equal to H(M→I). The two-sides distance is symmetric:

H(I [symbol] M)=max {H(I→M), H(M→I)}.

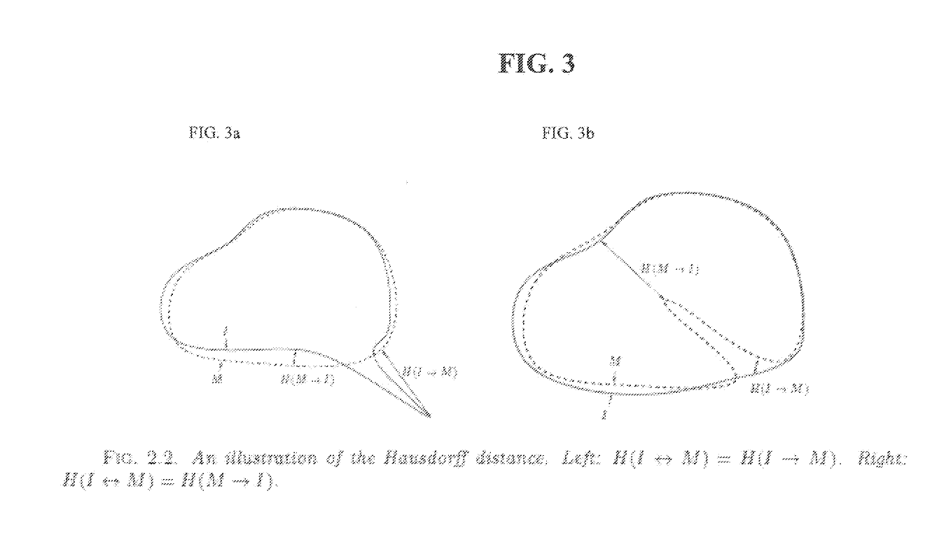

The Hausdorff distance corresponding to the above descriptions has been illustrated in FIG. 3a and FIG. 3b.

Input. The input may be a 2D or 3D image as known to ordinarily skilled artisans, such as a bitmap image in FIG. 2(a). Each voxel of the bitmap corresponds to a separate material or tissue. A user may supply a desired angle lower bound and fidelity bounds or may use default angle lower bound and default fidelity bounds. Letter θ* and H* are used to denote the bounds on the angle and the Hausdorff distance, respectively.

Construction of the Octree. An octree (in 3D) or a quadtree (in 2D) may be constructed that satisfies the following properties:

1. The octree (equivalently, its root node) completely encloses all the tissues from the image, except possibly for the background voxels that can be ignored.

2. There is extra space, equal to or greater than the maximum of the fidelity parameters, between the tissues and the exterior boundaries of the octree.

3. The boundaries between the leaves correspond exactly to the boundaries between the voxels. This is made possible by using integer coordinates corresponding to voxel indices.

4. No leaf contains voxels from multiple tissues. The nodes of the tree are split recursively until all of the leaves satisfy this condition.

5. The sizes of the octree leaves respect the 2-to-1 rule, i.e., two adjacent leaves must differ in depth by no more than one.

Computation of the Distance Transform. A distance transform of an image is an assignment to every voxel of a distance to the nearest feature of the image. In the example in FIG. 2(a), the features may the boundaries between the tissues, and the distance is measured in the usual Euclidean metric. See, e.g., FIG. 2(c), where darker shades correspond to the ⁻voxels that are closer to tissue boundaries. A Euclidean Distance Transform (EDT) algorithm described by Maurer [12] was implemented. This algorithm was chosen for two reasons: (1) its linear time complexity with respect to the number of voxels, and (2) it is formulated to work in an arbitrary dimension. The EDT computation was run on the extended image, i.e., the image is padded with imaginary background voxels (or truncated of the extra background voxels) to the size of the octree root node.

Labeling of Octree Leaves. For each leaf of the octree, find the maximum distance to the inter-tissue boundaries, using the EDT values of the voxels enclosed by this leaf. In FIG. 2(d) the leaves that are within the tolerance (2 voxels in this example) with transparent gray filling are marked.

Filling in the Octree. The leaves are processed in the order of their size, starting with the smallest, see FIG. 2(e) for a 2D example. The procedure is recursive on dimension: to triangulate an n-dimensional face of the leaf, first triangulate all of its (n-1)-dimensional sub-faces. If at least one of the (n-1)-dimensional sub-faces is split by a mid-point, introduce the mid-point of the n-dimensional face and connect to the elements of the (n-1)-dimensional triangulation of the sub-face to construct the n-dimensional triangulation of the face. If none of the sub-faces was split, use the diagonals of the face.

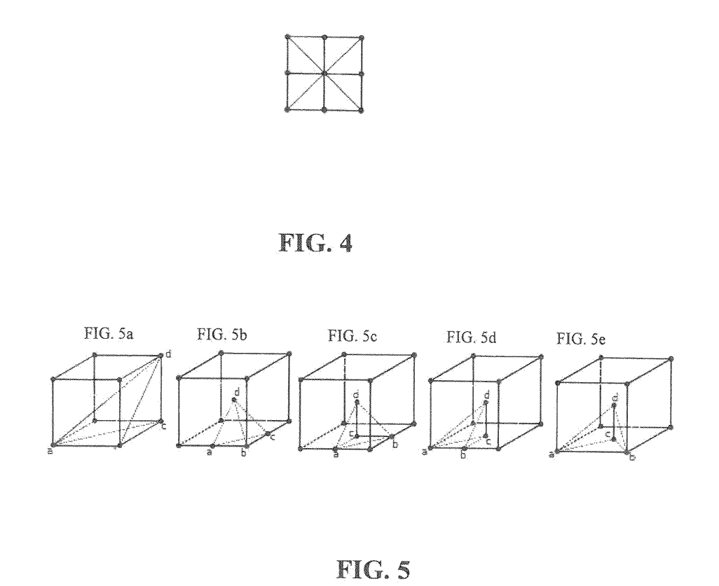

This procedure is equivalent to using a finite number of predefined canonic leaf triangulations, with the benefits of reducing manual labor and being applicable in an arbitrary dimension. For all possible resulting leaf triangulations we obtain a minimum planar angle of 45° in 2D or a minimum dihedral angle of 35.26° in 3D, please see FIGS. 4 and FIG. 5(a)-(e) for an illustration. Hence, these are the bounds that the algorithm can guarantee.

Once all octree leaves are filled with tetrahedra, we finish the construction of the mesh data structure by identifying face-adjacent tetrahedra, in order to facilitate the decimation procedure.

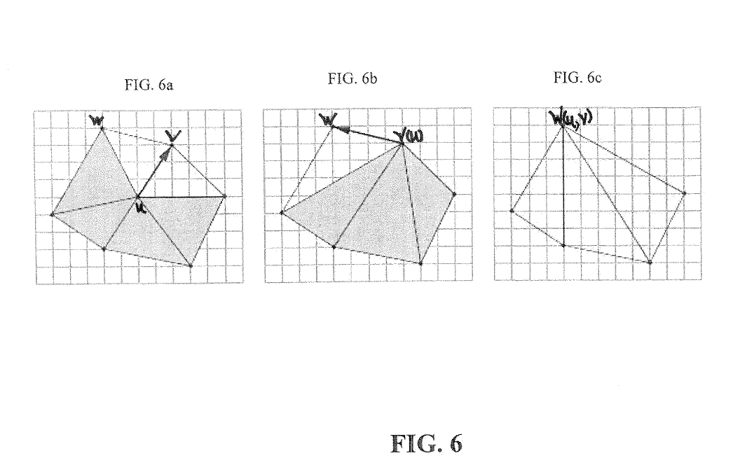

Mesh Decimation. Vertex u is merged to vertex v if vertex u and edge uv are removed from the mesh, such that all tetrahedra (triangles) incident upon edge uv are also removed from the mesh and the remaining edges that were incident upon u now become incident upon v. See FIG. 6(a)-(c) for an illustration.

A decimation algorithm is shown in follows:

```
DECIMATION( [symbol]   , [symbol]   , θ* , H*(I → M), H*(M → I))
Input: [symbol]   is the initial mesh [symbol]
      is the octree
      θ* is the lower bound on the minimum angle bound
      H*(I → M) and H*(M → I) are the upper bounds
      on one-sided Hausdorff distances
Output: Decimated mesh [symbol]   that respects angle and fidelity bounds
```

| | |
|---|---|
| 1: | Initialize Q to the set of all vertices in [symbol] |
| 2: | while Q ≠ |
| 3: | Pick vᵢ ε Q |
| 4: | Q ← Q \ {vᵢ} |
| 5: | Find A = {vⱼ} the set of vertices adjacent to vᵢ |
| 6: | for each vⱼ ε A |
| 7: | Find T = {tₖ} the set of tetrahedra incident |
| | upon vᵢ and not incident upon vⱼ |
| 8: | for each tₖ ε T |
| 9: | Replace vᵢ with vⱼ in tₖ |
| 10: | endfor |
| 11: | if (CHECK4QUALITY(T, θ*) [symbol] |
| | CHECK4FIDELITY(T, [symbol] , H*(I → M), |
| | H*(M → I)) [symbol] |
| | CHECK4CONNECTIVITY(T, [symbol] )) |
| 12: | Merge vᵢ to vⱼ, update [symbol] |
| 13: | Q ← Q ∪ A |
| 14: | break |
| 15: | endif |
| 16: | for each tₖ ε T |
| 17: | Replace vⱼ with vᵢ in tₖ |
| 18: | endfor |
| 19: | endfor |
| 20: | endwhile |
| 21: | return [symbol] |

A queue Q of mesh vertices that are candidates for merging is maintained. The algorithm removes from and adds vertices to Q until it becomes empty. Note that after the initialization a vertex can be added on the queue only as a result of a merge of an adjacent vertex. Therefore, when none of the vertices in Q passes the check for a merge, Q will become empty and the decimation procedure will terminate. Suppose n is the total number of vertices in the original mesh. Every vertex is added to Q once in the beginning. Afterwards, a vertex is added to Q only if one of its vertex neighbors was merged. If m is the total number of merges performed (obviously m<n), then the total number of evaluations is bounded from above by n+cm, where c is the maximum number of vertex neighbors for each vertex. For two dimensions, it is easy to see that c is constant: since at all times during the run of the algorithm the minimum planar angle is bounded by a constant threshold θ*, the degree of each vertex is bounded by 360/θ*. In three dimensions, there is no such clear relationship. The algorithm starts with a semi-regular filling of the octree in which the degree of each vertex is a small number, and then during decimation the maximum vertex degree can increase. For the three examples presented in the present disclosure with millions of vertices, the maximum observed vertex degree for the brain atlas is 187, for the abdominal atlas is 326, and for the ball is 420.

Maintaining Element Quality. The function CHECK4QuALITY(T, θ*) returns true if and only if all elements on the list T are not inverted and have all angles (planar in 2D or dihedral in 3D) above the bound θ*. Therefore, the merge is not accepted if at least one newly created angle is smaller than θ*.

Maintaining Fidelity to Boundaries. This check, represented by the function CHECK4FIDELITY(T, [symbol] , H*(I→M), H*(M→I)) consists of two parts, for each of the one-sided Hausdorff distances. To evaluate the distance from the boundary of the sub-mesh to the boundary of the corresponding tissue, for each of the boundary faces (edges in 2D or triangles in 3D) of elements in T, recursively check for the intersection with the octree nodes. If at least one of the faces intersects at least one of the nodes marked as outside the fidelity tolerance, the merge is discarded. To evaluate the distance from the boundary of each tissue to the boundary of the corresponding sub-mesh, for each vertex we maintain a cumulative list of the boundary vertices that were merged to it is maintained. If at least one of the boundary vertices, as a result of a sequence of merges, is further away from its original location than the corresponding fidelity tolerance, the merge is discarded.

Maintaining Tissue Connectivity. The geometric constructions used in the algorithm are assigned colors based on their location with respect to the tissues on the bitmap:

1. Each leaf of the octree (quadtree) derives the color from the block of voxels that it encloses; remember that the nodes are split recursively until they enclose voxels of a single color, in the limit case a leaf encloses a single voxel.

2. Each tetrahedron in 3D (or triangle in 2D) derives its color from the octree (quadtree) leaf that it is used to tetrahedralize; it keeps the original color even after it changes shape due to vertex merge. As a result, all tetrahedra (triangles) are always correctly classified with respect to the underlying tissues, including the quadruple-zero (triple-zero) ones.

3. Each vertex derives its color from the block of incident voxels (eight in 3D or four in 2D); if the block of voxels has multiple colors, the vertex is considered boundary.

The following rules help maintain the original structure of the inter-tissue boundaries: (1) boundary vertices cannot merge to non-boundary vertices, (2) a vertex cannot merge to a non-boundary vertex of a different color, and (3) a boundary vertex can merge to another boundary vertex only along a boundary edge—this helps to prevent the case when a vertex from one boundary merges to another boundary along a non-boundary edge, and thus the merge connects the parts of the boundaries that were not originally connected.

Implementation and Evaluation. In one embodiment the proposed Lattice Decimation can be implemented in (LD) algorithm in C⁺⁺, in both two and three dimensions. The following design implementation decisions can be implemented:

1. Most of the computation is performed in integer arithmetic. This is possible due to the fact that vertex coordinates are integers; they are indices with respect to the matrix of voxels. The only floating point computation is involved in the comparison of cosines of angles since long integer arithmetic could overflow. In addition, the lengths of the integer variables correspond to the range of values of each specific arithmetic operation, such that very long integers are used only when necessary to avoid overflow. For example, if variable x is represented with b bits, then x² requires 2b bits, while x⁴ requires 4b bits; using 4b bits for x² would be excessive.

2. All expensive mathematical functions, such as trigonometric, square root, etc., including floating point division, are avoided in the computationally critical parts. Instead, computation is performed on squares, cosines, and other functions of the original values.

3. Customized memory allocation functions were written, such that objects that are created in large numbers but occupy little memory each (vertices, tetrahedra, nodes of the tree) are allocated in contiguous memory buffers. This decreases memory fragmentation and allocation overheads.

4. The sequences of complex pass-fail condition evaluations such that the least expensive and the most likely to fail conditions are evaluated first, while the most expensive ones are evaluated last.

The performance of the algorithm in terms of the running time, as well as the number and the size of tetrahedra, depends on the input geometry. Therefore, in one embodiment, an approach to the evaluation is based on two experimental setups. The first setup uses a very simple 3D geometry (sphere) and evaluates the performance with respect to different sizes of the sphere. This way, insight into the performance for a controlled range of domain geometries with varied ratio of max_{pεΩ}, lfs(p)/min_{pεΩ}lfs(p) is gained. The local feature size function lfs(p) for a given point p is equal to the radius of the smallest ball centered at p that intersects two non-incident elements of domain Ω. For images, these elements are vertices, edges, and faces from the tissue boundary. For a sphere this ratio is simply equal to its radius, and therefore is easy to vary.

The second setup uses two complex real-world medical images: an abdominal atlas [18], and a brain atlas [19]. The atlases come with a segmentation, such that each voxel is assigned a label which corresponds to one of 75 abdominal and 149 brain tissues. All tests were performed on a desktop with Intel(R) Core™ i7 CPU@2.80 GHz and 8 GB of main memory.

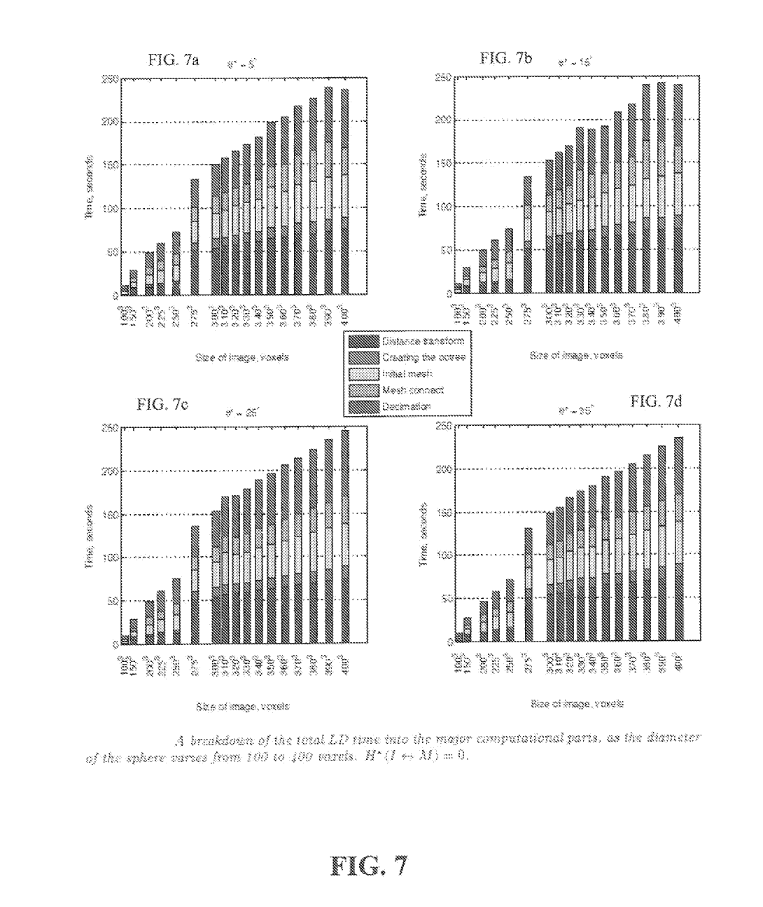

Synthetic Benchmark—3D Sphere. FIGS. 7(a)-(d) show a breakdown of the total time into the major computational parts, as the diameter of the sphere grows from 100 to 400 voxels. These parts are the computation of the distance transform, the construction of the octree, the construction of the initial mesh that fills the leaves of the octree, the finding of the connectivity among the tetrahedra of the initial mesh (which is expensive because involves a search through the adjacent leaves), and the decimation. Here and in all other time measurements we exclude the time taken by input/output and by the process of initializing the data structure representing the initial image. Thus the conclusion is that all components represented in the figure grow approximately linear with respect to the total number of voxels in the image, while the sharp jump between the diameter values of 250 and 275 corresponds to the increase of the octree size which can only take values of powers of two.

The following table shows the output mesh size of one embodiment of an implementation for a sphere of a fixed diameter of 400 voxels. In the embodiment, having fixed the dihedral angle bound and the diameter of the sphere, each of the two one-sided Hausdorff distance bound parameters are varied independently. Four columns are presented, for different interesting values of the dihedral angle bound (5, 15, 25, and 35 degrees) spread through the range of its feasible values (0 to 35.26 degrees). As can be seen from the table, for all configurations the output mesh size is high when either one or both of the H* parameters is low and decreases as the H* bounds decrease. Indeed, the weaker constraints can be satisfied with a smaller number of tetrahedra. The same argument explains why the final number of tetrahedra grows as the dihedral angle bound increases. The total running time in these tests does not change significantly with the variation of the fidelity bounds and is close to 250 seconds. The actually obtained smallest dihedral angles in all experiments are between θ* and θ*+0.3°.

| H* | H* | Resulting number of tetrahedra | | | |
|---|---|---|---|---|---|
| (I → M) | (M → I) | θ* = 5° | θ* = 15° | θ* = 25° | θ* = 35° |
| 0 | 0 | 2,676,905 | 3,533,827 | 6,228,998 | 7,568,401 |
| 0 | 1 | 2,628,051 | 3,486,279 | 6,192,725 | 7,585,208 |
| 0 | 2 | 1,051,537 | 1,828,910 | 5,228,905 | 6,810,152 |
| 0 | 4 | 1,049,190 | 1,831,595 | 5,241,114 | 6,816,286 |
| 0 | 6 | 1,052,819 | 1,833,990 | 5,239,028 | 6,810,705 |
| 0 | 8 | 1,050,645 | 1,830,927 | 5,239,671 | 6,812,804 |
| 0 | 10 | 1,049,490 | 1,828,948 | 5,235,814 | 6,805,851 |
| 1 | 0 | 2,674,541 | 3,536,514 | 6,231,690 | 7,585,208 |
| 1 | 1 | 2,619,272 | 3,483,032 | 6,180,726 | 7,585,208 |
| 1 | 2 | 615,495 | 1,294,315 | 4,832,255 | 6,702,274 |
| 1 | 4 | 622,144 | 1,296,503 | 4,845,919 | 6,708,335 |
| 1 | 6 | 620,531 | 1,286,649 | 4,853,066 | 6,700,642 |
| 1 | 8 | 621,753 | 1,288,004 | 4,832,317 | 6,707,849 |
| 1 | 10 | 618,635 | 1,287,916 | 4,833,412 | 6,695,580 |
| 2 | 0 | 2,678,337 | 3,528,875 | 6,219,659 | 7,567,694 |
| 2 | 1 | 2,622,046 | 3,471,997 | 6,169,755 | 7,567,694 |
| 2 | 2 | 420,742 | 954,058 | 4,761,521 | 6,689,753 |
| 2 | 4 | 420,287 | 963,392 | 4,767,670 | 6,694,121 |
| 2 | 6 | 418,914 | 956,169 | 4,767,004 | 6,687,824 |
| 2 | 8 | 418,605 | 967,353 | 4,761,786 | 6,693,867 |
| 2 | 10 | 415,096 | 957,492 | 4,764,773 | 6,682,444 |
| 4 | 0 | 2,680,017 | 3,529,907 | 6,227,939 | 7,572,235 |
| 4 | 1 | 2,610,273 | 3,470,074 | 6,181,200 | 7,572,235 |
| 4 | 2 | 206,744 | 669,844 | 4,761,246 | 6,693,880 |
| 4 | 4 | 205,792 | 669,727 | 4,761,246 | 6,693,880 |
| 4 | 6 | 201,715 | 674,707 | 4,761,532 | 6,687,545 |
| 4 | 8 | 197,087 | 664,810 | 4,757,938 | 6,693,670 |
| 4 | 10 | 198,760 | 662,854 | 4,765,483 | 6,682,099 |
| 6 | 0 | 2,673,759 | 3,528,173 | 6,222,394 | 7,567,112 |
| 6 | 1 | 2,618,425 | 3,470,097 | 6,173,119 | 7,567,112 |
| 6 | 2 | 108,961 | 627,153 | 4,761,532 | 6,687,545 |
| 6 | 4 | 108,667 | 627,153 | 4,761,532 | 6,687,545 |
| 6 | 6 | 108,667 | 627,153 | 4,761,532 | 6,687,545 |
| 6 | 8 | 111,692 | 616,427 | 4,757,938 | 6,693,670 |
| 6 | 10 | 109,520 | 600,885 | 4,765,479 | 6,682,099 |
| 8 | 0 | 2,673,161 | 3,527,634 | 6,221,837 | 7,569,203 |
| 8 | 1 | 2,612,149 | 3,467,740 | 6,174,740 | 7,569,203 |
| 8 | 2 | 76,523 | 604,821 | 4,757,938 | 6,693,670 |
| 8 | 4 | 76,108 | 604,795 | 4,757,938 | 6,693,670 |
| 8 | 6 | 76,108 | 604,795 | 4,757,938 | 6,693,670 |
| 8 | 8 | 76,108 | 604,795 | 4,757,938 | 6,693,670 |
| 8 | 10 | 78,542 | 594,901 | 4,765,479 | 6,685,099 |
| 10 | 0 | 2,671,255 | 3,534,080 | 6,216,296 | 7,567,005 |
| 10 | 1 | 2,613,405 | 3,466,948 | 6,167,959 | 7,567,005 |
| 10 | 2 | 58,510 | 593,862 | 4,765,479 | 6,682,099 |
| 10 | 4 | 56,975 | 593,519 | 4,765,479 | 6,682,099 |
| 10 | 6 | 56,975 | 593,519 | 4,765,479 | 6,682,099 |
| 10 | 8 | 56,975 | 593,519 | 4,765,479 | 6,682,099 |
| 10 | 10 | 56,975 | 593,519 | 4,765,479 | 6,682,099 |

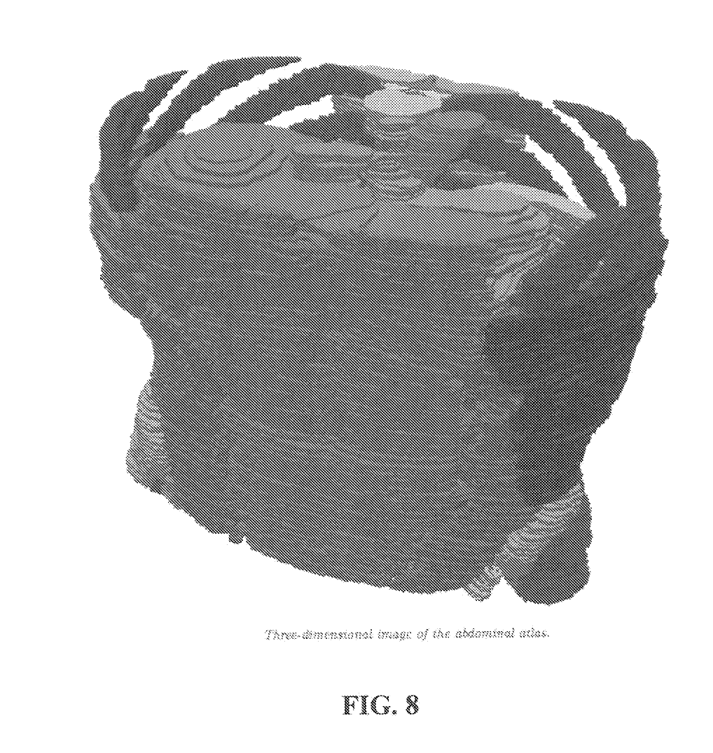

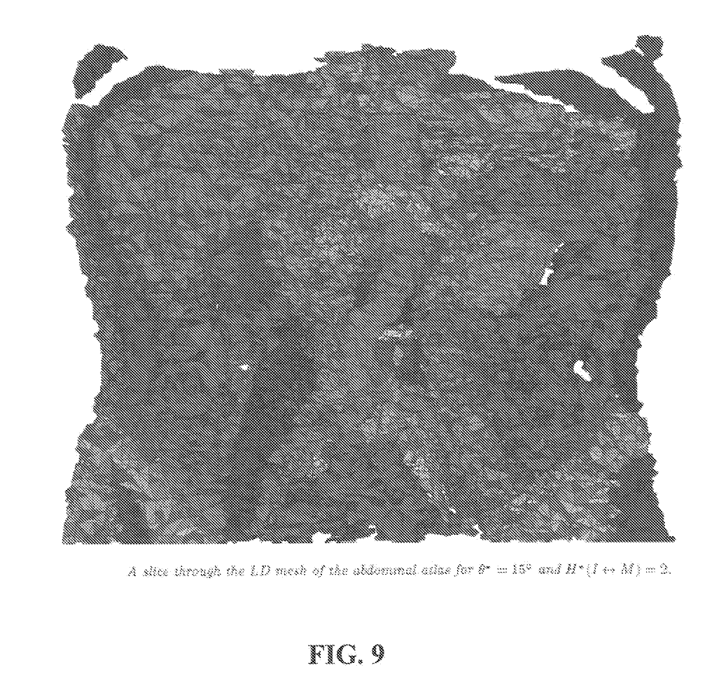

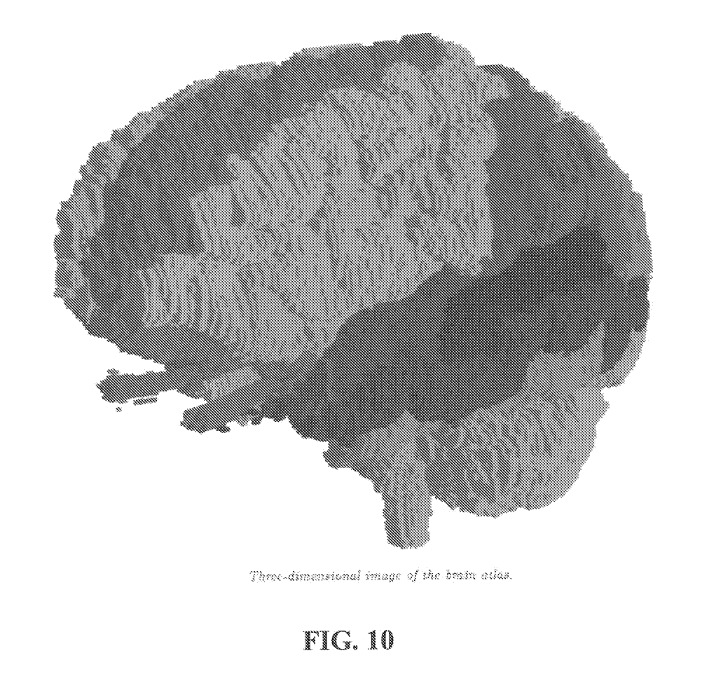

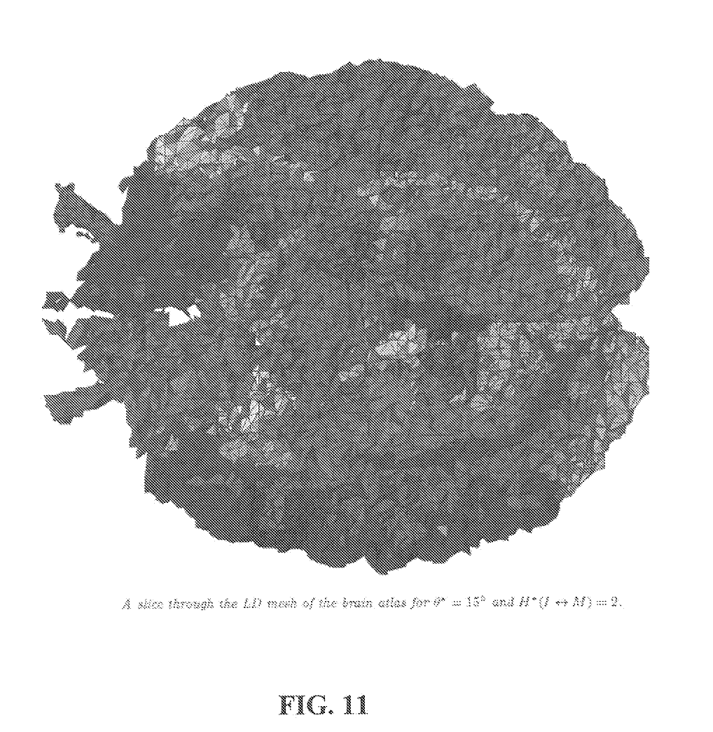

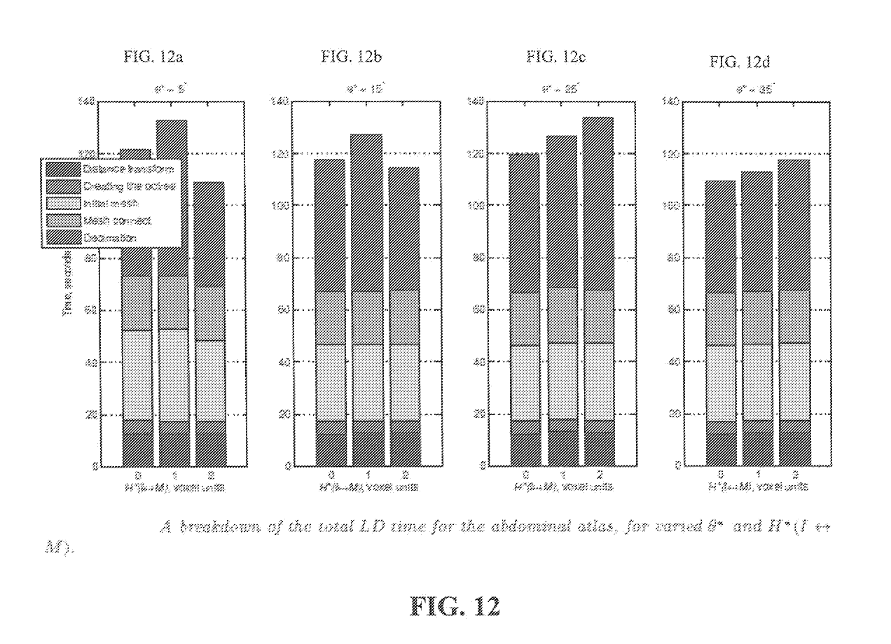

Three-Dimensional Medical Images. The size of the abdominal atlas is 256×256×113 voxels and the size of the brain atlas is 256×256×159 voxels, as shown in FIG. 8. In both cases each voxel has side lengths of 0.9375, 0.9375, and 1.5000 units in x, y, and z directions respectively. Before meshing the atlases, the atlases are resampled with voxels of equal side length corresponding to the original 0.9375 units. As a result, in both cases were obtained equally spaced images that were used for meshing. FIGS. 8-11 show the atlas images and corresponding three-dimensional meshes.

In the following table are listed the final number of tetrahedra, the smallest dihedral angle, and the total running time for both images, as the H* and θ* parameters are varied. To obtain a point of reference for these numbers, a separate experiment was conducted using a state-of-the art open source tetrahedral mesh generator Tetgen [16]. Tetgen is designed to work with Piecewise Linear Complexes (PLCs), and not images. Therefore, to make it process the same tissue geometries, extract the voxel faces corresponding to the boundaries between different tissues and between the tissues and the surrounding space, and saved them in the PLC format files that are passed to Tetgen. The main difference between the two methods is that Tetgen does not provide any guarantees on the dihedral angle (since it is designed to improve only circumradius-to-shortest edge ratio of tetrahedra for general PLCs), and its empirical smallest dihedral angle will generally be different for other input geometries. As can be expected, the meshes produced by Tetgen had low smallest dihedral angles, around 5°. At the same time, Lattice Decimation (LD) algorithm can provide guaranteed smallest dihedral angles up to 35.26° for all input images.

| | | | Resulting mesh statistics | | | | | |
|---|---|---|---|---|---|---|---|---|
| | | | Number of | | Smallest | | Total | |
| | Input bounds | | tetrahedra | | dih. angle | | time | |
| Code | H*(I [symbol] M) | θ* | AA | BA | AA | BA | AA | BA |
| Tetgen | 0 (implicit) | n/a | 3,501,569 | 3,398,654 | 4.725 | 5.002 | 169 | 128 |
| LD | 0 | 5 | 3,332,477 | 3,267,276 | 5.002 | 5.003 | 122 | 74 |
| | | 15 | 3,932,131 | 3,698,787 | 15.002 | 15.002 | 120 | 74 |
| | | 25 | 6,768,472 | 6,266,442 | 25.066 | 25.066 | 120 | 73 |
| | | 35 | 7,806,292 | 6,773,951 | 35.264 | 35.264 | 110 | 68 |
| | 1 | 5 | 3,134,565 | 3,126,393 | 5.000 | 5.005 | 134 | 82 |
| | | 15 | 3,714,781 | 3,555,290 | 15.002 | 15.002 | 128 | 82 |
| | | 25 | 6,415,049 | 6,082,604 | 25.066 | 25.066 | 127 | 75 |
| | | 35 | 7,625,360 | 6,657,475 | 35.264 | 35.264 | 115 | 68 |
| | 2 | 5 | 557,242 | 521,952 | 5.000 | 5.002 | 111 | 71 |
| | | 15 | 924,642 | 874,764 | 15.000 | 15.000 | 116 | 77 |
| | | 25 | 4,506,340 | 5,137,417 | 25.061 | 25.066 | 135 | 83 |
| | | 35 | 6,658,700 | 6,318,544 | 35.097 | 35.264 | 119 | 71 |

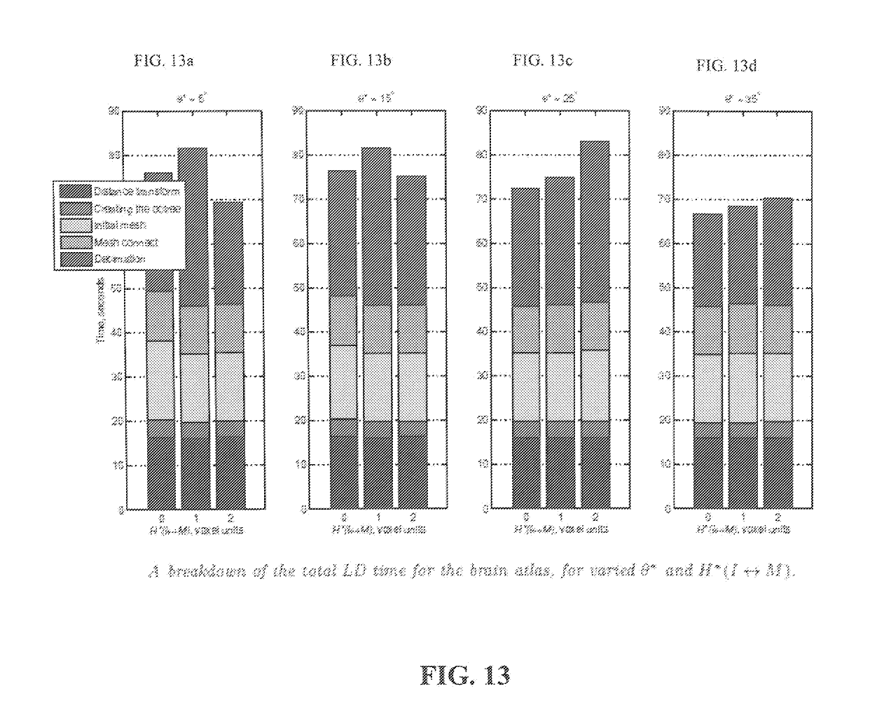

For all time measurements, exclude all data preprocessing, such as image resampling, surface extraction, and input/output. We see that LD implementation is faster than Tetgen by a significant margin for both atlas images. FIGS. 12(a)-(d) and FIGS. 13(a)-(d) show breakdowns of the total LD time into the main computational components as the symmetric Hausdorff distance bound changes from 0 to 2 voxels. Similar to the case of the sphere, little change both in the running time and in its distribution with the variation of H* and 0* parameters is shown.

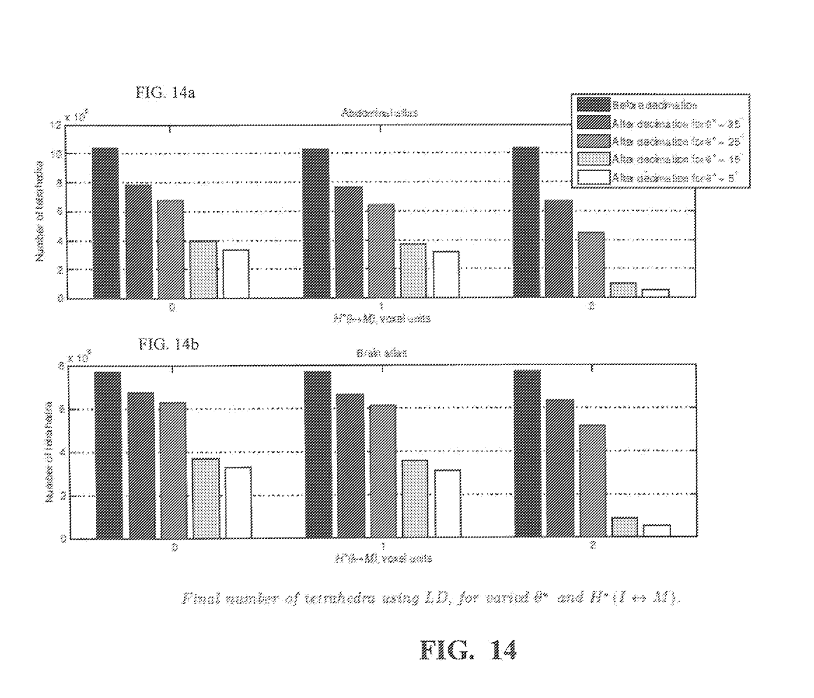

As far as the number of tetrahedra, the difference between Tetgen and LD is insignificant, although in both cases in favor of LD, for the bound of H*(I [symbol] M)=0 which allows for a comparison with respect to the same fidelity, and θ*=5° which is close to the empirical Tetgen angles. In FIGS. 14(a) and (b) we show the final number of tetrahedra for both atlases, as vary H*(I [symbol] M) and θ* are varied.

The following table presents the experimental evaluation of the I2M conversion functionality offered by Computational Geometry Algorithms Library (CGAL) [1]. A function make_mesh_{—}3 with the following parameters was used:

domain is the brain or abdominal atlas image without resampling,

facet_angle is a lower bound on the planar angle of boundary faces; set it to an ignored value,

facet_size is an upper bound on the radii of the surface Delaunay balls; set it to an ignored value,

facet_distance is an upper bound on the distance between the circumcenters of surface facets and the centers of the corresponding surface Delaunay balls; vary this parameter as shown in the table,

cell_radius_edge_ratio is an upper bound on radius-edge ratio of tetrahedra; use 2.0,

facet_size is an upper bound on the circumradii of the mesh tetrahedra; set it to an ignored value,

lloyd(), odt(), perturb(), exude() with the corresponding no prefixes are available mesh optimization functions; the default usage is no lloyd(), no odt(), perturb(), exude(); use four combinations specified in the table with all the default arguments.

| | Resulting mesh statistics | | | | | | | |
|---|---|---|---|---|---|---|---|---|
| | # of | | Smallest | | # of | | Total | |
| | tetrahedra | | dih. angle | | subdoms. | | time | |
| facet_distance | AA | BA | AA | BA | AA | BA | AA | BA |

no_lloyd( ), no_odt( ), perturb( ), exude( )

| | | | | | | | | |
|---|---|---|---|---|---|---|---|---|
| 0.5 | 659,104 | 751,640 | 2.833 | 2.365 | 74 | 145 | 65.5 | 50.4 |
| 1.0 | 174,080 | 209,437 | 3.355 | 2.246 | 74 | 143 | 18.0 | 16.5 |
| 2.0 | 44,108 | 51,772 | 4.504 | 3.586 | 74 | 138 | 3.9 | 3.8 |

no_lloyd( ), odt( ), perturb( ), exude( )

| | | | | | | | | |
|---|---|---|---|---|---|---|---|---|
| 0.5 | 659,641 | 753,978 | 1.012 | 1.185 | 74 | 145 | 342.9 | 251.7 |
| 1.0 | 173,554 | 209,457 | 0.815 | 0.812 | 74 | 144 | 103.4 | 82.2 |
| 2.0 | 43,197 | 51,603 | 1.588 | 2.943 | 73 | 141 | 81.5 | 60.7 |

lloyd( ), no_odt( ), perturb( ), exude( )

| | | | | | | | | |
|---|---|---|---|---|---|---|---|---|
| 0.5 | 643,371 | 745,864 | 1.277 | 2.041 | 74 | 144 | 2533.7 | 1017.4 |
| 1.0 | 171,117 | 207,582 | 2.983 | 1.211 | 74 | 143 | 513.8 | 179.9 |
| 2.0 | 42,903 | 52,688 | 0.090 | 1.182 | 74 | 140 | 124.0 | 73.4 |

lloyd( ), odt( ), perturb( ), exude( )

| | | | | | | | | |
|---|---|---|---|---|---|---|---|---|
| 0.5 | 651,023 | 756,038 | 1.695 | 0.371 | 74 | 144 | 3571.6 | 956.0 |
| 1.0 | 173,512 | 212,914 | 2.009 | 3.388 | 74 | 143 | 468.8 | 202.7 |
| 2.0 | 44,357 | 53,192 | 2.223 | 2.799 | 74 | 138 | 138.4 | 111.8 |

In addition to the quantities measured in the previous experiments, also query subdomain_index for each tetrahedron of the resulting mesh. Then count the total number of unique subdomain indexes and compared with the number of unique voxel labels in the image (75 for the abdominal atlas and 149 for the brain atlas).

Similar to Tetgen, mesh generation in CGAL consists of two phases, the construction of the initial mesh and its improvement as a post-processing step. The first phase in both Tetgen and CGAL uses a variation of the Delaunay refinement approach which guarantees only a bound on radius-edge ratio. The second, optimization, phase improves other mesh properties such as the dihedral angles. Using various combinations of optimization algorithms implemented in CGAL, minimum dihedral angles of 5° or more could not be obtained. The final number of tetrahedra produced by CGAL is significantly smaller than produced by LD, however, at the expense of occasionally not representing some of the tissues from the image. CGAL's processing time varies significantly, from much lower than that of LD, to order of magnitude higher, depending on the selection of mesh optimization algorithms.

The present disclosure has set forth a guaranteed quality and fidelity image-to mesh conversion algorithm and its efficient sequential implementation. The algorithm preserves not only external boundaries, but also the boundaries between multiple tissues which make the resulting meshes suitable for finite element simulations of multi-tissue regions with different physical tissue properties.

### REFERENCES

The following references, which are referred to throughout this disclosure, are each incorporated by reference in their entirety hereby:

[1] Computational Geometry Algorithms Library at http://www.cgal.org.

[2] DOBRINA BOLTCHEVA, MARIETTE YVINEC, AND JEAN-DANIEL BOISSONNAT, Mesh generation from 3^{d} multi-material images, in Proceedings of the 12^{th} International Conference on Medical Image Computing and Computer-Assisted Intervention: Part II, Berlin, Heidelberg, 2009, Springer-Verlag, pp. 283-290.

[3] SIU-WING CHENG, TAMAL K. DEY, HERBERT EDELSBRUINNER, MICHAEL A. FACELLO, AND SHANG-HUA TENG, SLIVER EXUDATION, J. ACM, 47 (2000), pp. 883-904.

[4] L. PAUL CHEW, Guaranteed-quality Delaunay meshing in 3D, in Proceedings of the 13^{th} ACM Symposium on Computational Geometry, Nice, France, 1997, pp. 391-393.

[5] ANDRIY FEDOROV AND NIKOS CHRISOCHOIDES, Tetrahedral mesh generation for non-rigid registration of brain MRI: Analysis of the requirements and evaluation of solutions, in Proceedings of the 17^{th} International Meshing Roundtable, Pittsburgh, Pa., October 2008, Springer, pp. 55-72.

[6] PAUL-LOUIS GEORGE AND HOUMAN BOROUCHAKI, Delaunay Triangulation and Meshing. Application to Finite Elements, HERMES, 1998.

[7] HUGUES HOPPE, TONY DEROSE, TOM DUCHAMP, JOHN MCDONALD, AND WERNER STUETZLE, Mesh optimization, in Proceedings of the 20^{th} Annual Conference on Computer Graphics and Interactive Techniques, New York, N.Y., USA, 1993, ACM, pp. 19-26.

[8] FRANCOIS LABELLE AND JONATHAN RICHARD SHEWCHUK, Isosurface stuffing: Fast tetrahedral meshes with good dihedral angles, ACM Transactions on Graphics, 26 (2007), pp. 57.1-57.10.

[9] XIANG-YANG LI AND SHANG-HUA TENG, Generating well-shaped Delaunay meshes in 3D, in Proceedings of the 12^{th} annual ACM-SIAM symposium on Discrete algorithms, Washington, D.C., 2001, pp. 28-37.

[10] YIXUN LIU, PANAGIOTIS FOTEINOS, ANDREY CHERNIKOV, AND NIKOS CHRISOCHOIDES, Multi-tissue mesh generation for brain images, in Proceedings of the 19^{th} International Meshing Roundtable, Chattanooga, Tenn., October 2010, Springer, pp. 367-384.

[11] DAVID P. LUEBKE, A developer's survey of polygonal simplification algorithms, IEEE Comput. Graph. Appl., 21 (2001), pp. 24-35.

[12] CALVIN MAURER, RENSHENG QI, AND VIJAY RAGHAVAN, A linear time algorithm for computing exact Euclidean distance transforms of binary images in arbitrary dimensions, IEEE Transactions on Pattern Analysis and Machine intelligence, 25 (2003), pp. 265-270.

[13] RENATO PAJAROLA AND JAREK ROSSIGNAC, Compressed progressive meshes, IEEE Transactions on Visualization and Computer Graphics, 6 (2000), pp. 79-93.

[14] J.-P. PONS, F. S'EGONNE, J.-D. BOISSONNAT, L. RINEAU, M. YVINEC, AND R. KERIVEN, High-quality consistent meshing of multi-label datasets, in Proceedings of the 20^{th} international conference on Information processing in medical imaging, Berlin, Heidelberg, 2007, Springer-Verlag, pp. 198-210.

[15] WILLIAM J. SCHROEDER, JONATHAN A. ZARGE, AND WILLIAM E. LORENSEN, Decimation of triangle meshes, in Proceedings of the 19^{th} annual conference on Computer graphics and interactive techniques, New York, N.Y., USA, 1992, ACM, pp. 65-70.

[16] TETGEN http://tetgen.berlios.de

[17] ROBERT STAUBS, ANDRIY FEDOROV, LEONIDAS LINARDAKIS, BENJAMIN DUNTON, AND NIKOS CHRISOCHOIDES, Parallel n-dimensional exact signed Euclidean distance transform, Insight Journal, (2006). http://hdl.handle.net/1926/307.

[18] I. TALOS, M. JAKAB, AND R. KIKINIS, SPL abdominal atlas. 2010 http://www.spl.harvard.edu/publications/item/view/1918, 10 2010.

[19] I. TALOS, M. JAKAB, R. KIKINIS, AND M. SHENTON, SPL-PNL brain atlas. http://www.spl.harvard.edu/publications/item/view/1265, 03 2008.

[20] JOE F. THOMPSON, BHARAT K. SONI, AND NIGEL P. WEATHERILL, Handbook of Grid Generation, CRC Press, 1998.

[21] JANE TOURNOIS, RAHUL SRINIVASAN, AND PIERRE ALLIEZ, Perturbing slivers in 3D Delaunay meshes, in Proceedings of the 18^{th} International Meshing Roundtable, Brett W. Clark, ed., Springer, 2009, pp. 157-173.

[22] JINGQI YAN, PENGFEI SHI, AND DAVID ZHANG, Mesh simplification with hierarchical shape analysis and iterative edge contraction, IEEE Transactions on Visualization and Computer Graphics, 10 (2004), pp. 142-151.

[23] O. C. ZIENKIEWICZ, R. L. TAYLOR, AND J. Z. ZHU, The Finite Element Method: Its Basis and Fundamentals, Butterworth-Heinemann; 6′¹¹ edition, 2005.

While the invention has been described and illustrated with reference to certain preferred embodiments herein, other embodiments are possible. Additionally, as such, the foregoing illustrative embodiments, examples, features, advantages, and attendant advantages are not meant to be limiting of the present invention, as the invention may be practiced according to various alternative embodiments, as well as without necessarily providing, for example, one or more of the features, advantages, and attendant advantages that may be provided by the foregoing illustrative embodiments.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

What is claimed is:

1. A computer-aided design method for generating mesh from an image using a computer, the method being implemented by a computer system operatively connected to at least one data storage device in which is stored image data for images, at least one computer and at least one computer readable medium storing thereon computer code which when executed by the at least one computer performs the method, the method comprising:
setting a quality bound and a fidelity bound for a mesh to be generated for an image;
generating an initial mesh for the image with a quality bound and the fidelity bound; and
generating a refined mesh by coarsening the initial mesh while maintaining the quality bound and the fidelity bound,
wherein the refined mesh includes a smaller number of elements than that of the initial mesh.

2. The method according to claim 1, wherein the quality bound includes a dihedral angle requirement, and the fidelity bound includes a Hausdorff distance requirement.

3. The method according to claim 1, wherein the image is a three-dimensional image, and
wherein the initial mesh generating step includes:
generating a mesh formed by a plurality of voxels, each of which is assigned a uniformed material property, and
distributing the voxels through triangulation.

4. The method according to claim 3, wherein the voxels are assigned integer coordinates corresponding to voxel indices.

5. The method according to claim 1, wherein the refining step includes:
merging selected vertexes with adjacent vertex, the vertexes being selected according to the quality bound and the fidelity bound so that after merge, the quality bound and the fidelity bound of the mesh are still satisfied.

6. The method according to claim 5, wherein a boundary vertex is merged only with anther boundary vertex that is on the same boundary as the boundary vertex.

7. A recording medium storing a program that instructs a computer to generate a mesh from an image, the method being implemented by a computer system operatively connected to at least one data storage device in which is stored image data for images, at least one computer and at least one computer readable medium storing thereon computer code which when executed by the at least one computer performs the method, the method comprising according to a method including:
setting a quality bound and a fidelity bound for a mesh to be generated;
generating an initial mesh for the image with the according to the quality bound and the fidelity bound;
generating a refined mesh by coarsening the initial mesh while maintaining the quality bound and the fidelity bound;
wherein the refined mesh includes a smaller number of elements than that of the initial mesh.

8. The recording medium according to claim 7, wherein the quality bound includes a dihedral angle requirement, and the fidelity bound includes a Hausdorff distance requirement.

9. The recording medium according to claim 7, wherein the image is a three-dimensional image, and
wherein the initial mesh generating step includes:
generating a mesh overlaying a plurality of voxels, each of which is assigned a uniformed material property, and
distributing the voxels through triangulation.

10. The recording medium according to claim 9, wherein the voxels are assigned integer coordinates corresponding to voxel indices.

11. The recording medium according to claim 7, wherein the refining step includes:
merging selected vertexes with adjacent vertex, the vertexes being selected according to the quality bound and the fidelity bound so that after merge, the quality bound and the fidelity bound of the mesh are still satisfied.

12. The recording medium according to claim 11, wherein a boundary vertex is merged only with anther boundary vertex that is on the same boundary as the boundary vertex.

13. A system for performing a process on an image, the process being implemented by a computer system operatively connected to at least one data storage device in which is stored image data, and comprising at least one computer and at least one computer readable medium storing thereon computer code which when executed by the at least one computer performs a method, the method comprising the at least one computer:
setting a quality bound and a fidelity bound for a mesh to be generated for an image;
generating an initial mesh for the image according to the quality bound and the fidelity bound;
generating a refined mesh by coarsening the initial mesh while maintaining the quality bound and the fidelity bound;
wherein the refined mesh includes a smaller number of elements than that of the initial mesh.

14. The system according to claim 13, wherein the quality bound includes a dihedral angle requirement, and the fidelity bound includes a Hausdorff distance requirement.

15. The system according to claim 13, wherein the image is a three-dimensional image, and
wherein the initial mesh generating step includes:
generating a mesh formed by a plurality of voxels, each of which is assigned a uniformed material property, and
distributing the voxels through triangulation.

16. The recording medium according to claim 15, wherein the voxels are assigned integer coordinates corresponding to voxel indices.

17. The system according to claim 13, wherein the refining step includes:
merging selected vertexes with adjacent vertex, the vertexes being selected according to the quality bound and the fidelity bound so that after merge, the quality bound and the fidelity bound of the mesh are still satisfied.

18. The system according to claim 17, wherein the system is configured to merge a boundary vertex only with another boundary vertex that is on the same boundary as the boundary vertex.
